(19) United States
(12) Patent Application Publication
(10) Pub. No.: US 2011/0197150 A1
(43) Pub. Date: Aug. 11, 2011

(54) METHOD FOR CHECKING UPDATES OF REGIONS OF WEB PAGES

(76) Inventor: YEN-CHENG HUANG, Xinzhuang City (TW)

(21) Appl. No.: 12/704,509

(22) Filed: Feb. 11, 2010

(51) Int. Cl. G06F 3/01; G06F 3/048

(52) U.S. Cl. 715/760; 715/823

(57) ABSTRACT

When a web page is visited in a browser, the method automatically loads a tool bar so that a user could specify the visited web page to be tracked or one or more regions of the visited web page to be tracked (or excluded). Then, at the specified periods or instants, the method automatically checks to see if the web pages or regions of web pages are updated. If updates are detected, colored and audible notification is provided. A user then can select an updated web page to view and locates the spot(s) where update takes place. The notification of update of a specific web page or region could be provided by the method as a RSS or web service for other third-party applications.

### (a) TECHNICAL FIELD OF THE INVENTION

The present invention generally relates to methods for checking web pages updates, and more particularly to a method that automatically tracks updates of multiple web pages or regions of web pages, and automatically locates the contents that has been updated.

### (b) DESCRIPTION OF THE PRIOR ART

Due to their ubiquity, people's daily life has become highly dependent on of Internet and World Wide Web (WWW). However, when a web page is updated, people are not immediately notified of such change. A user would learn the web page's update only after the user has visited the updated web page. Usually, when the user actually makes the visit, the change has already happened for a period of time. Taking on-line auction as example, as a bidder is not notified about the bidding in real time, the bidder would lose the bid. Even though some web pages do provide subscription mechanisms such as RSS and Atom, the information provided by these mechanisms is not necessarily appropriate to a user's requirement. The user can only passively accept whatever these mechanisms provide.

Further, none of products on the market utilizes cross browser embedded tool bar to provide region tracking function thereby making it very difficult to check what part of the web page is updated.

### SUMMARY OF THE INVENTION

Therefore, a novel for tracking web page update is provided herein. The method allows the specification one or more web pages or regions in web pages and the method automatically check to see if these web pages or regions of web pages have been updated at specified periods or instants. When updates are detected, the method provides visual and audible notifications and allows the viewing of the updated web pages.

When a web page is visited in a browser, the method automatically loads a tool bar so that a user could specify the visited web page to be tracked or one or more regions of the visited web page to be tracked (or excluded). After specification, the user could resume normal browsing or other activities. Then, at the specified periods or instants, the method automatically checks to see if the web pages or regions of web pages are updated. If updates are detected, colored and audible notification is provided. A user then can select an updated web page to view and locates the spot(s) where update takes place. The notification and content of update of a specific web page or region could be provided by the method as a RSS or web service for other third-party applications.

A user can also select specific regions by loaded tool bar to monitor updates for those regions. The way to select regions can be done either by dragging mouse cursor to or selecting a specific region in the web page.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow diagram showing the steps of checking web page update of a method according to an embodiment of the present invention.

FIG. 2 is a screen capture showing a system window provided by the present invention.

FIG. 3 is a screen capture showing a “Trace it” button on a tool bar provided by the present invention in a browser window.

FIG. 4 is a screen capture showing the settings of a configuration window provided by the present invention.

FIG. 5 is a screen capture showing additional settings of the configuration window of FIG. 4.

FIG. 6 is a screen capture showing the system window of FIG. 2 when viewing an updated web page that has been added to the system.

FIG. 7 is a partial screen capture showing a task icon and a notification window provided by the present invention.

FIG. 8 is a screen capture showing a pull-down menu with “what's different” item of the system window of FIG. 6.

FIG. 9 is a screen capture showing an updated web page where the updated spot is marked and shown with the original content provided by the present invention.

FIG. 10 is a screen capture showing a “Partial trace it” button on the tool bar of FIG. 3.

FIG. 11 is a screen capture showing a web page region is automatically highlighted by the present invention.

FIG. 12 is a screen capture showing the highlighted web page region of FIG. 11 when it is included or excluded for tracking by a user.

FIG. 12A is a screen capture showing web pages regions selected by dragging for tracking updates manually by a user.

FIG. 13 is a screen capture showing the settings of a configuration window provided by the present invention after selected multiple web page regions for tracking updates.

FIG. 14 is a screen capture showing a web page having updates with no comparison in unselected region.

FIG. 15 is a screen capture showing a third-part application subscribing to a RSS notification of a specific web page's update provided by the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

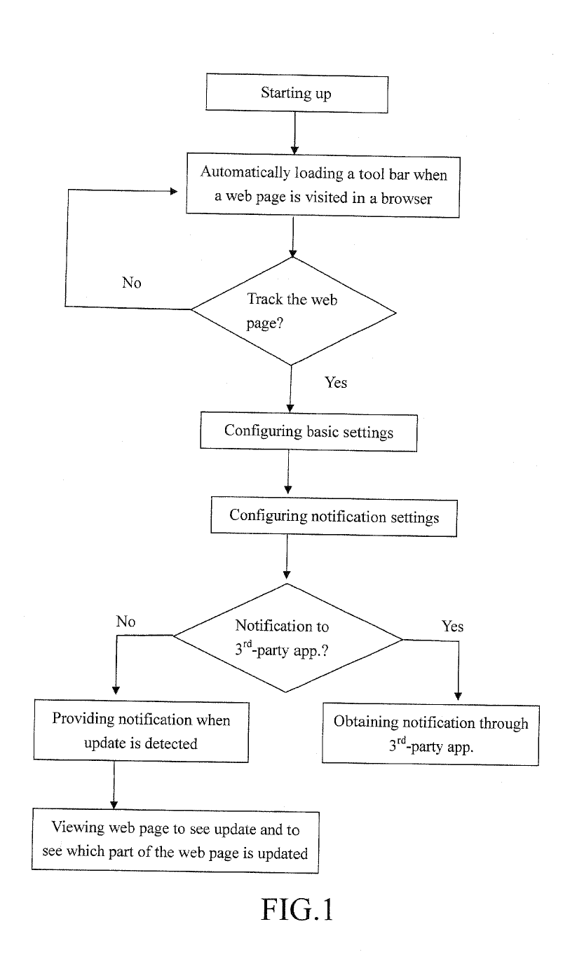

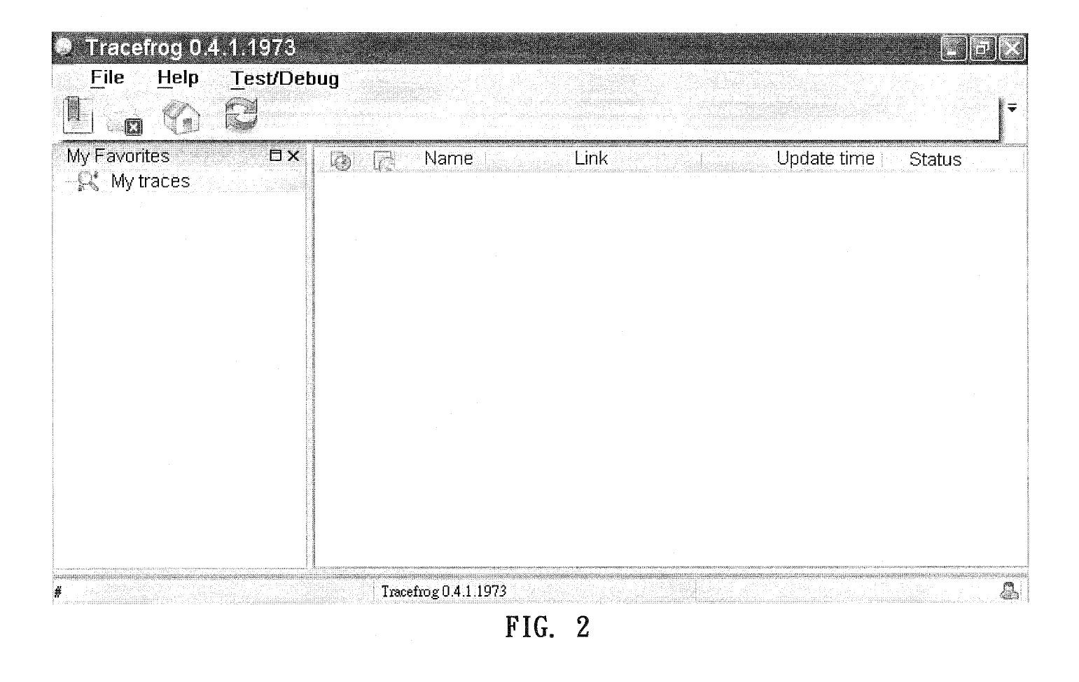

FIG. 1 is a flow diagram showing the steps of checking web page update of a method according to an embodiment of the present invention. As illustrated, first, when the method is started up, a system window is displayed on a monitor screen as shown in FIG. 2. In a left pane of the system window, a list of categories of the web pages to be checked is shown. In a right pane of the window, a list of web pages in a category currently selected in the left pane is shown. Initially, there is no category and no web page to be checked, as shown in FIG. 2.

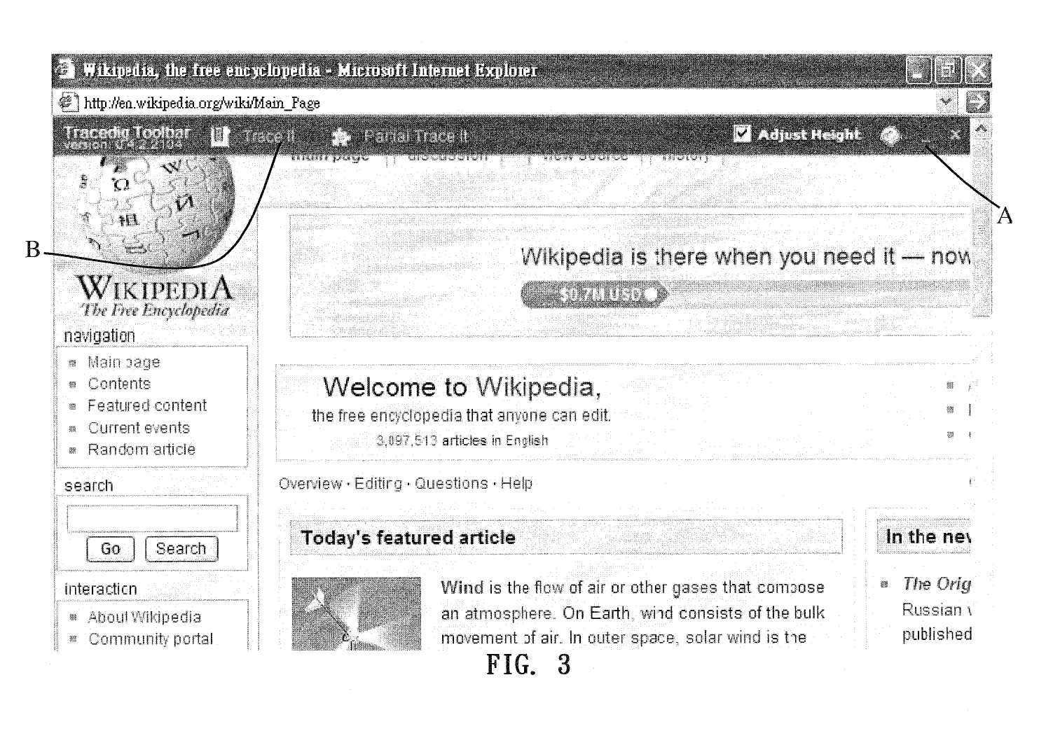

Then, in a browser's window, a tool bar (A of FIG. 3) is automatically loaded whenever a web page is visited. Then, if a web page visited and shown in the browser is to be checked for update, a “Trace it” button (B of FIG. 3) is provided in the tool bar.

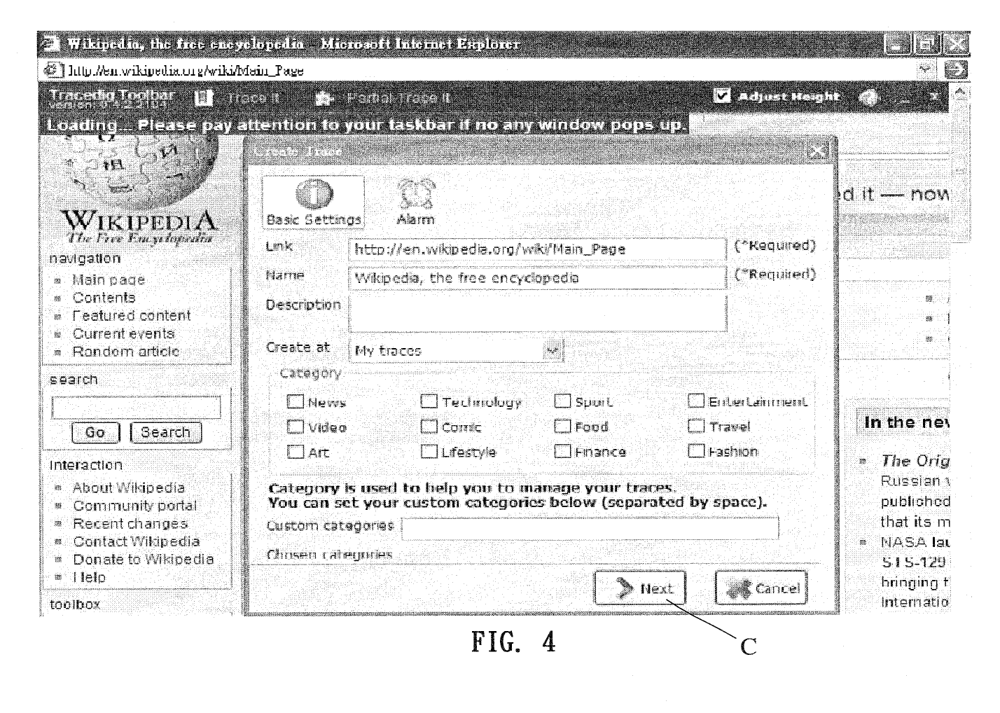

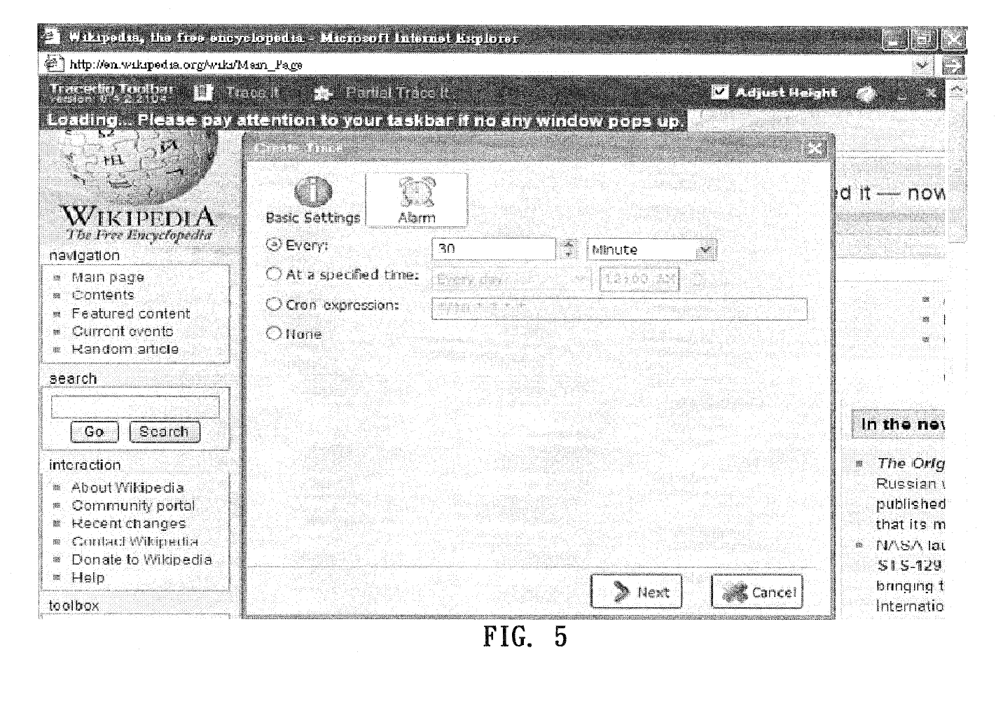

When the button is clicked, a configuration window is popped up as in FIG. 4 and a number of basic settings for the web page's tracking are provided for configuration. Then, when a “next” button of the configuration window is clicked, a number of notification settings are provided for configuration as shown in FIG. 5.

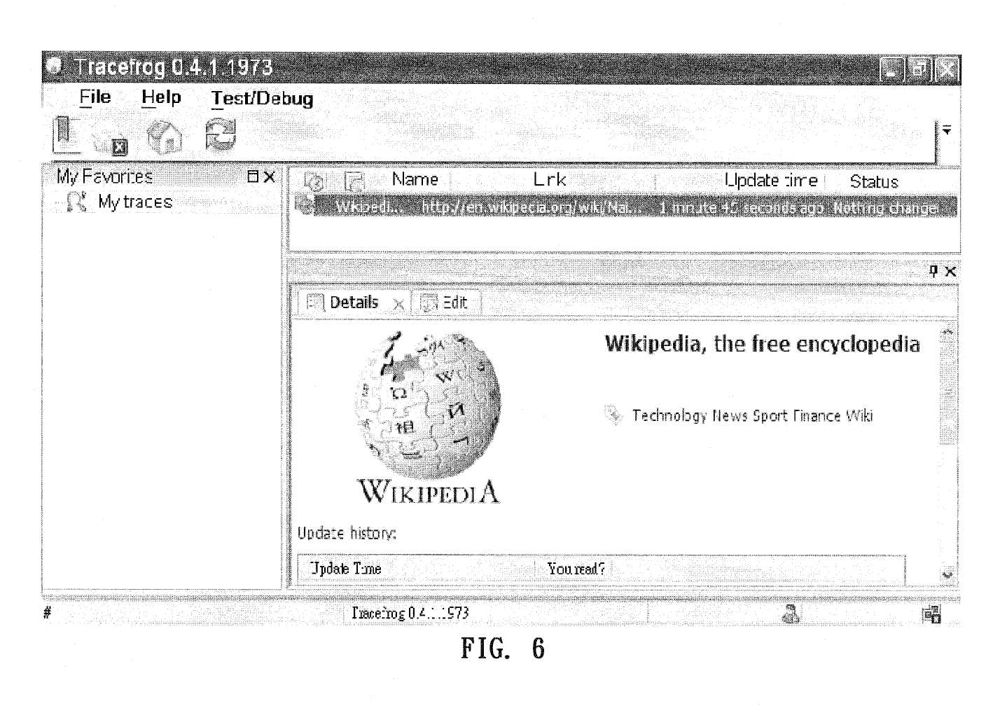

The web page's checking thereby could be configured to be performed every few minutes, few hours, few days, or few months. It is also possible to specify that the checking is performed at specific hour and minute each day. After confirmation by a user, the web page is added in the system window as shown in FIG. 6.

Till now, a web page to be checked for update is recorded in the system window of the method. A user could resume his or her browsing or any other activities. Then, at the aforementioned specified period or instant, the method would automatically check to see if the web page is updated.

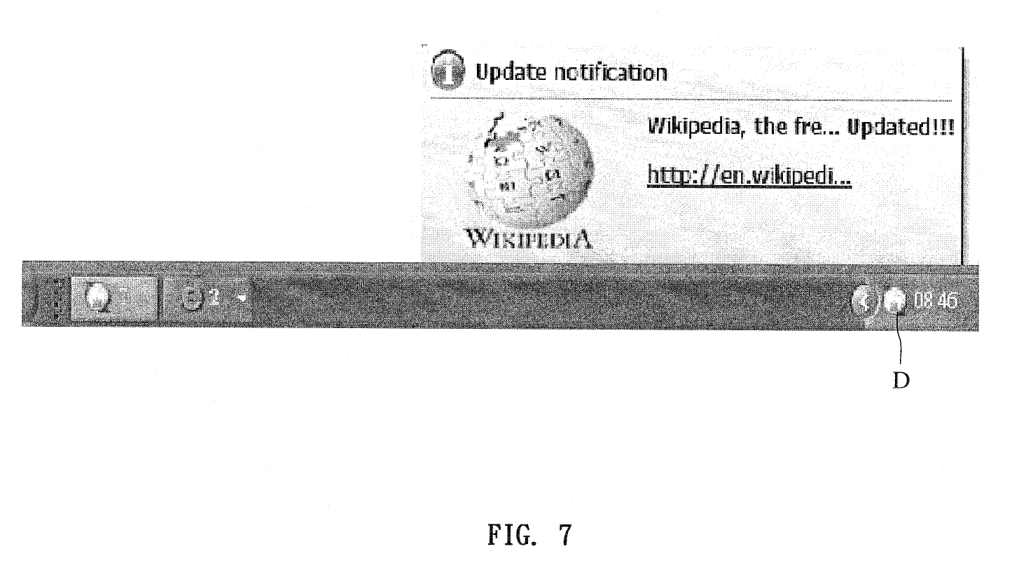

The system window is shrunk to a task icon in a task bar on the monitor screen (D of FIG. 7). When the method detects that a web page is updated, a notification window is scrolled up from the task bar in a specific color with audible alert sound and the detected web page is listed as shown in FIG. 7. If multiple web pages are detected to have updates, they are stacked in a list in the notification window.

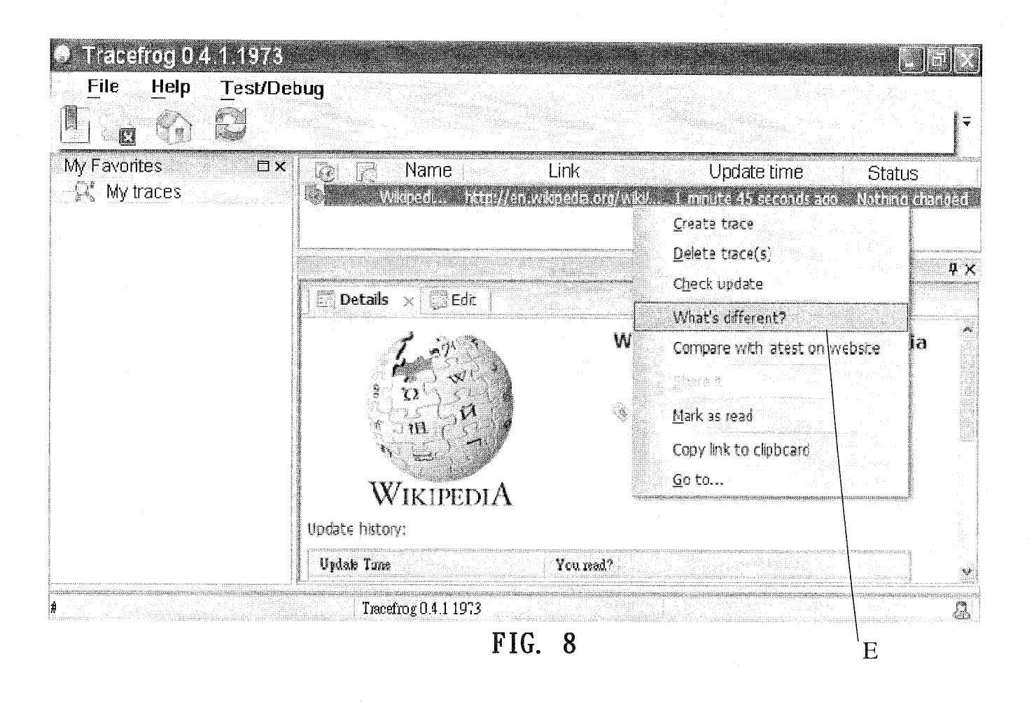

To see what has been changed in a web page, the web page's listed item in the notification window is clicked and the web page is popped up. The user may click the connection thereon to open the update web page. If it is desired to see the difference, the user may click the item which has already been added. Then, the right pane of the web page is split vertically into two halves. The relevant data in connection with the tracing and the updated web page in reduction size is displayed in the lower half as shown in FIG. 8. A “what's different” item in a pull-down menu (E of FIG. 8) is provided to see which part of the web page is updated.

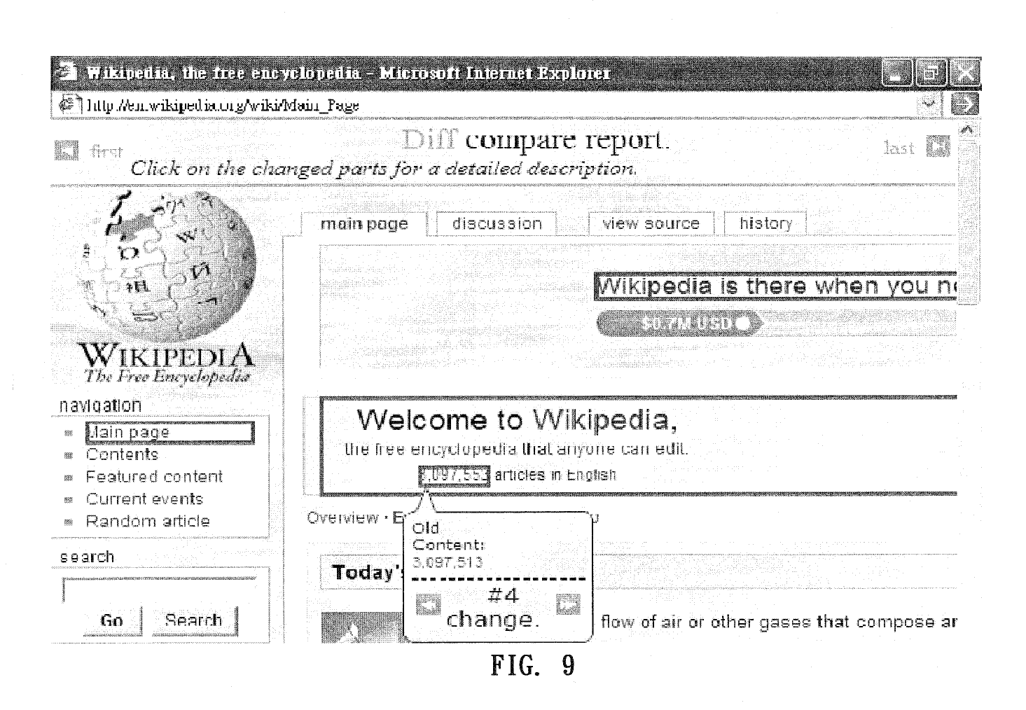

As shown in FIG. 9, the method marks the updated content (e.g., the number 3,097,553) and provides the original content (e.g., the number 3,097,513) in a box. By clicking the arrow heads in the box, the method would jump to a previous spot or a next spot where update takes place.

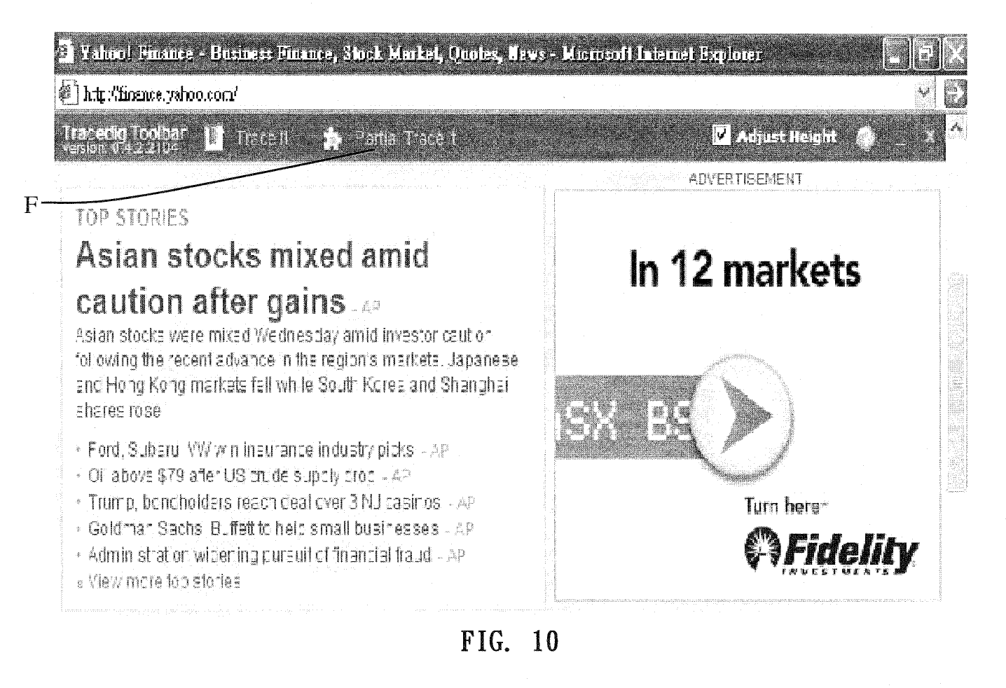

If a user only interests in learning whether a region of a web page has been updated instead of the whole web page, the method provides a “Partial trace it” button in the tool bar (F of FIG. 10).

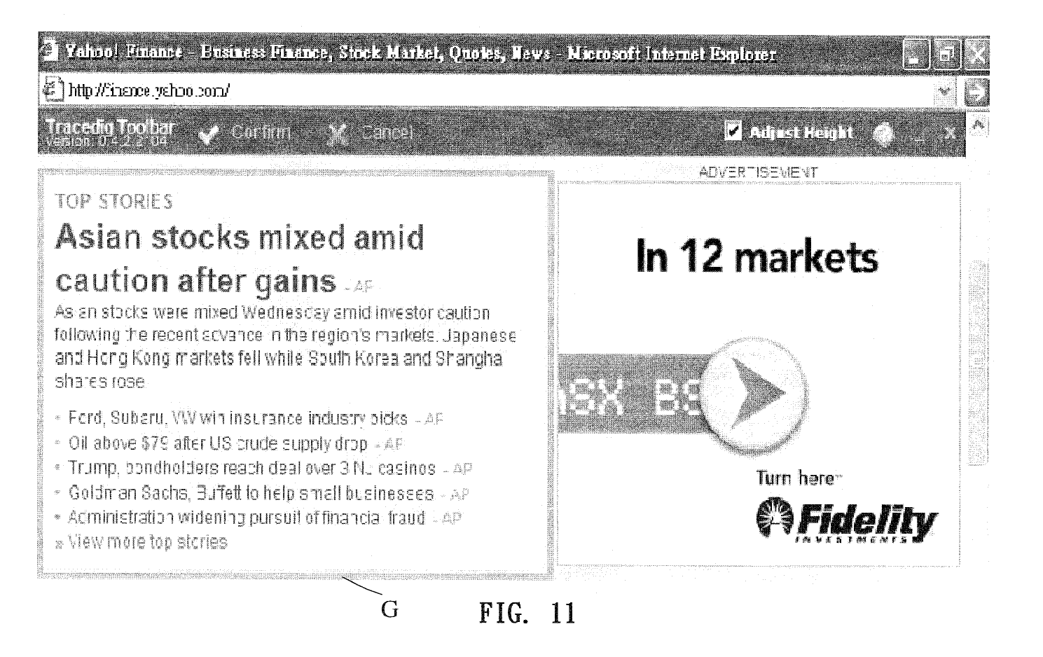

After clicking the “Partial trace it” button, when the mouse cursor is moved across the web page, the method would automatically highlight a region under the mouse cursor (G of FIG. 11) according to the web page's structure.

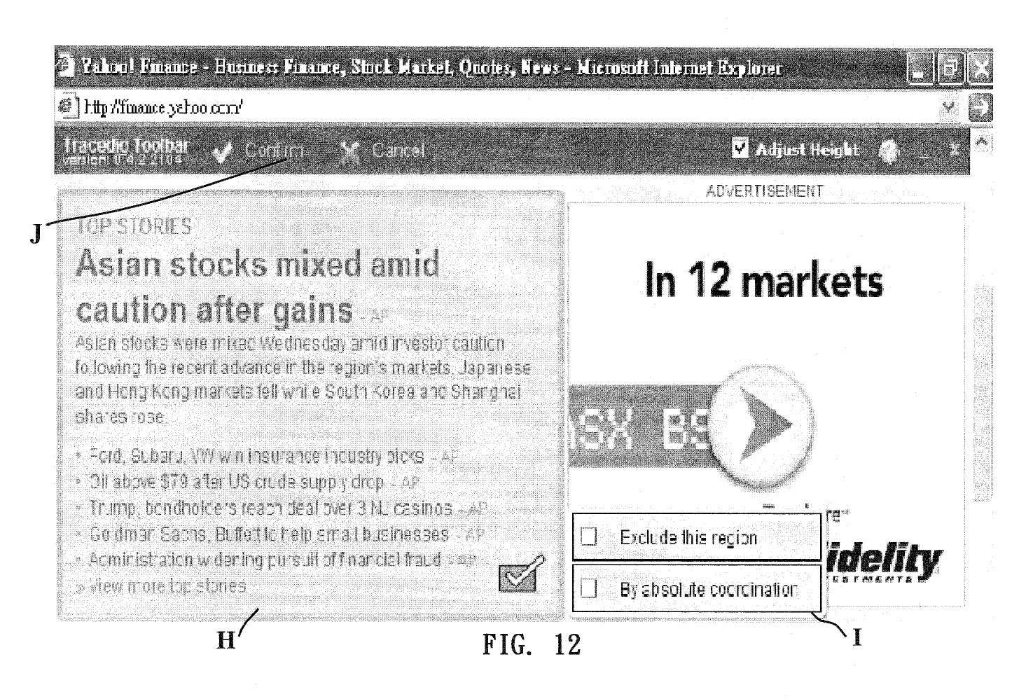

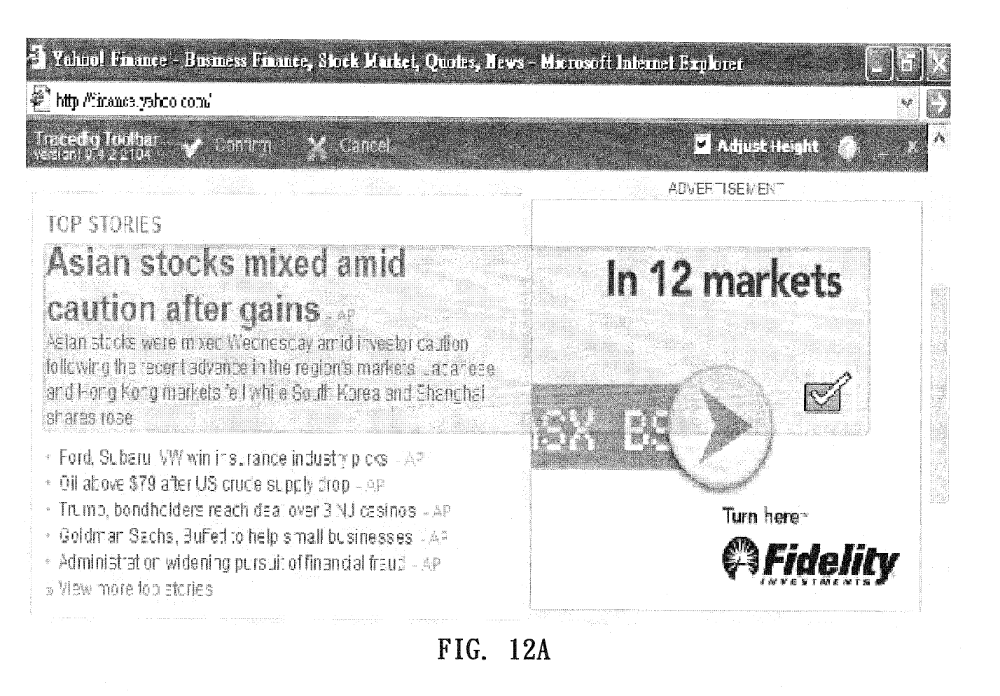

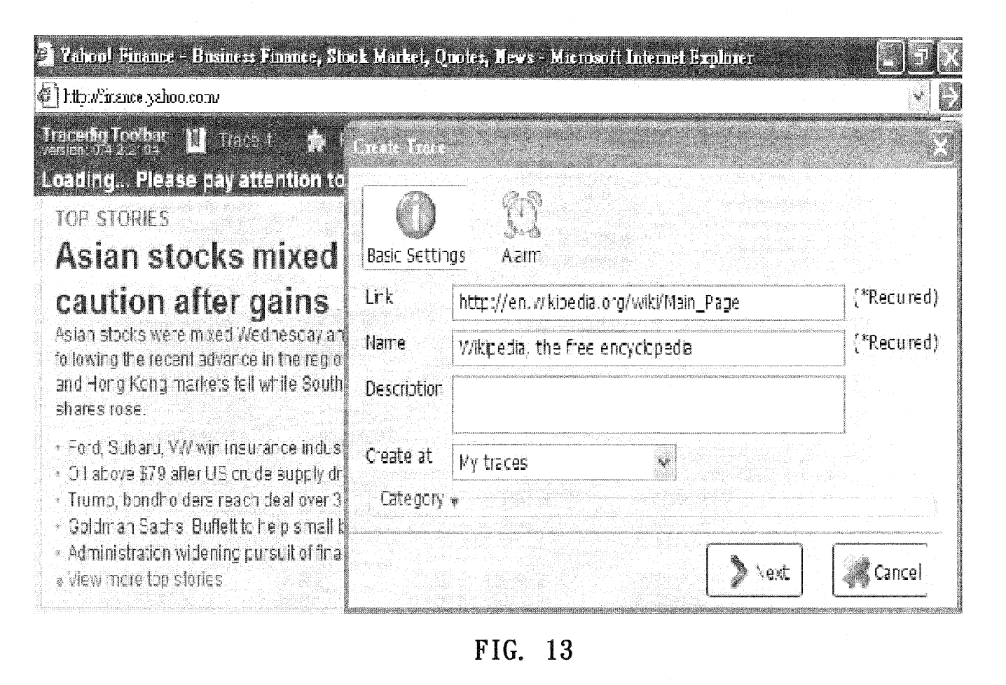

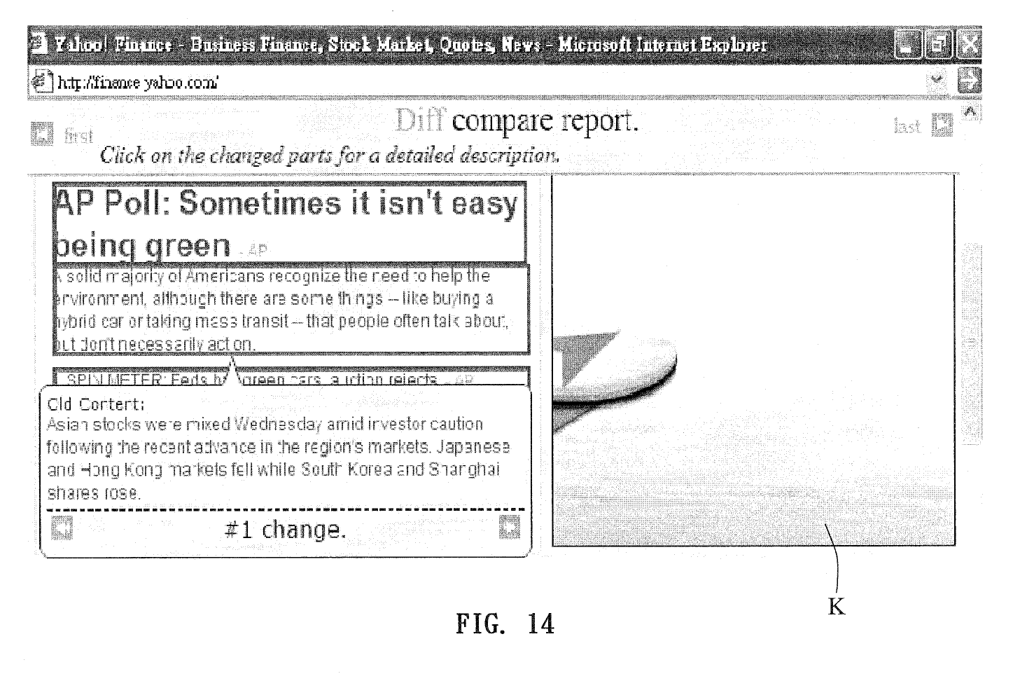

When a region is highlighted and the left mouse button is clicked, the method check-marks the region (H of FIG. 12) to indicate that the region is recorded for tracking. By repeating the foregoing steps, multiple regions in a web page could be selected and tracked. After a region is highlighted and the right mouse button is clicked, a pop-up menu (I of FIG. 12) is displayed to allow a user to specify whether to include or exclude the region for tracking. The method also allows a user to drag the mouse cursor on a web page to select the region(s) to be tracked as shown in FIG. 12A. After all the required regions are selected and a “Confirm” button (J of FIG. 12) in the tool bar is clicked, all the selected regions are recorded in the system window and the configuration window is popped up as shown in FIG. 13. As described earlier, in the configuration window, the user could specify the checking period or instants for updates. When other region of a web page (K of FIG. 14) is updated, if the region is not tracked, the method does not provide any comparison.

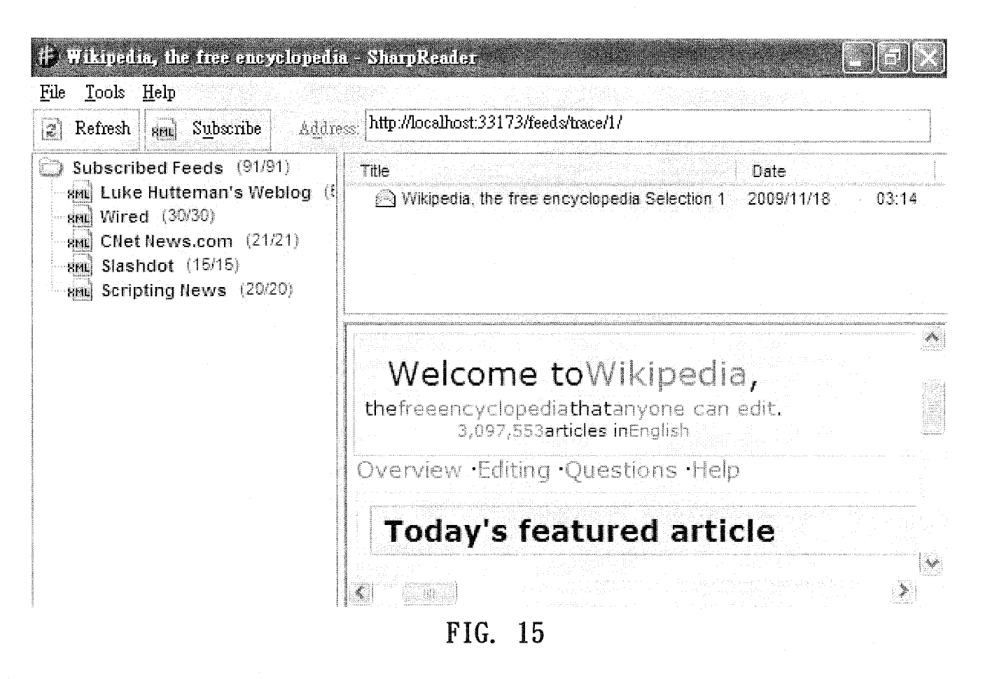

The method further provides a subscription mechanism such as RSS so that a third-part application could be used to subscribe the notification of a specific web page's update provided by the method. For example, in FIG. 15, an application program SharpReader has subscribed a web page update notification of the method and the method provides update notification to the SharpReader program through RSS. Additionally, the method could further provide its notification as a web service so that other third-party application could directly call the web service to access the updated information and content.

While certain novel features of this invention have been shown and described and are pointed out in the annexed claim, it is not intended to be limited to the details above, since it will be understood that various omissions, modifications, substitutions and changes in the forms and details of the method illustrated and in its operation can be made by those skilled in the art without departing in any way from the spirit of the present invention.

I claim:

1. A method for checking web page update, comprising the steps of:
providing a tool bar in a browser when a web page is visited by said browser;
recording said web page for tracking update when a first control button of said tool bar is clicked;
providing a configuration window for specifying at least when said web page is checked for update;
when reaching said specified time, checking said web page to see if there is update;
when a web page is detected to have been updated, providing a notification window with audible alert sound; and
visiting said updated web page for viewing its update;
wherein a user may track a web page update through subscription or call of other program and the user may select a certain region of a web page for tracking update.

2. The method according to claim 1, wherein said specification of when said web page is checked for update comprises one of a time interval for periodically checking said web page and a specific time instant.

3. The method according to claim 1, wherein if multiple web pages are detected to have updates, they are stacked in a list in the notification window.

4. The method according to claim 1, further comprising the step of when said updated web page is visited, providing a means to compare said updated web page with its original content.

5. The method according to claim 4, wherein said means provides jumping to the spot where update takes place and the spot's original content for comparison.

6. The method according to claim 1, further comprising the step of when a web page is detected to have been updated, providing notification and content through one of a RSS mechanism and a web service.

7. The method according to claim 1, further comprising the steps of:
highlighting a region of said web page under mouse cursor after a second control button of said tool bar is clicked; and
recording a highlighted region for tracking update when said highlighted region is selected.

8. The method according to claim 1, further comprising the steps of:
highlighting one or more regions of said web page and clicking a right mouse button to display a pop-up menu to allow a user to specify whether to include or exclude the regions for tracking.

9. The method according to claim 7, further comprising the steps of:
highlighting a region of said web page by dragging within a range manually defined by a user after a second control button of said tool bar is clicked; and
recording a highlighted region for tracking or exclusion from tracking update when said highlighted region is selected.

10. The method according to claim 7, further comprising the steps of:
providing a configuration window for specifying at least when said region is checked for update;
when reaching said specified time, checking said region to see if there is update;
when a region is detected to have been updated, providing a notification window with audible alert sound; and
visiting said web page for viewing said region.
